(19) United States
(12) Patent Application Publication
(10) Pub. No.: US 2009/0158758 A1
(43) Pub. Date: Jun. 25, 2009

(54) INDOOR AIR CONDITIONER AND OPERATION CONTROL METHOD THEREOF

(75) Inventor: Katsunori Eguchi, Ehime (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD., Osaka (JP)

(21) Appl. No.: 12/094,040

(22) PCT Filed: Nov. 24, 2006
(86) PCT No.: PCT/JP2006/323479

§ 371 Date: Feb. 6, 2009

(30) Foreign Application Priority Data
Dec. 1, 2005 (JP) 2005-348097

(51) Int. Cl. G05D 23/00; G05B 15/00

(52) U.S. Cl. 62/157; 700/275

(57) ABSTRACT

The present inventors took notice of the fact that a person has constant repetitive nature in timing of restart of an indoor air conditioner after the OFF timer was ended, and it is an object of the present invention to provide an indoor air conditioner and an operation control method thereof capable of obtaining comfortable sleep by setting an automatic start condition suitable for a user. The indoor air conditioner includes an OFF timer function for continuing the operation until set time is elapsed, time elapsed until restart by restart input means 15 after an OFF timer is ended is stored in automatic start time storing means 35 as automatic start time, and a room temperature at the time of restart is stored in automatic start temperature/humidity storing means 36 as automatic start temperature.

### TECHNICAL FIELD

The present invention relates to an indoor air conditioner for conditioning air, and an operation control method of the indoor air conditioner.

### BACKGROUND TECHNIQUE

A conventional indoor air conditioner has an OFF timer function for delaying operation of the air conditioner by a predetermined time at sleeping time and an ON timer function for starting the air conditioner at wake-up time.

### SUMMARY OF THE INVENTION

Since it is difficult to control a body heat during sleeping, if the end time of the OFF timer is delayed too much or if the start time of the ON timer is set too early, a user's throat may be damaged or the user may catch cold, but after the OFF timer is ended, the user may have a trouble sleep and may restart the air conditioner in some cases.

### DISCLOSURE OF THE INVENTION

The present inventor took notice of the fact that a person had constant repetitive nature in timing of restart of an indoor air conditioner after the OFF timer was ended, and it is an object of the present invention to provide an indoor air conditioner and an operation control method thereof capable of obtaining comfortable sleep by setting an automatic start condition suitable for a user.

A first aspect of the present invention provides an operation control method of an indoor air conditioner having an OFF timer function for continuing operation until set time is elapsed, comprising: a standby mode step for establishing a standby mode after an OFF timer is ended, and an automatic start condition storing step for storing time elapsed until the restart time after the OFF timer is ended as automatic start time, and for storing a room temperature at the time of the restart as an automatic start temperature when restart is manually carried out at the time of the standby mode, when the standby mode is established in the standby mode step, an automatic start time lapse determining step for determining whether the already stored automatic start time is elapsed, and an automatic start temperature achievement determining step for determining whether a current temperature reaches the already stored automatic start temperature, wherein when it is determined that the automatic start time has not yet been elapsed in the automatic start time lapse determining step, automatic start is not carried out even if the current temperature reaches the automatic start temperature, even if it is determined that the automatic start time has been elapsed in the automatic start time lapse determining step, if it is determined that the current temperature does not reach the automatic start temperature in the automatic start temperature achievement determining step, the automatic start is not carried out, and when it is determined that the automatic start time has been elapsed in the automatic start time lapse determining step and that the current temperature reaches the automatic start temperature in the automatic start temperature achievement determining step, the automatic start is carried out.

According to a second aspect of the invention, in the operation control method of the indoor air conditioner of the first aspect, if restart is manually carried out when the standby mode is established in the standby mode step and it is determined that the automatic start time has not yet been elapsed in the automatic start time lapse determining step, time elapsed until the restart after the OFF timer is ended and a room temperature at the time of the restart are newly stored.

According to a third aspect of the invention, in the operation control method of the indoor air conditioner of the second aspect, the newly stored time elapsed until the restart after OFF timer is ended and a room temperature at the time of the restart are applied as a new automatic start time and automatic start temperature instead of the already stored automatic start time and automatic start temperature.

According to a fourth aspect of the invention, in the operation control method of the indoor air conditioner of the second aspect, an automatic start condition is calculated using the newly stored time elapsed until the restart after OFF timer is ended and a room temperature at the time of the restart, and the already stored automatic start time and automatic start temperature.

According to a fifth aspect of the invention, in the operation control method of the indoor air conditioner of the fourth aspect, in the calculation of the automatic start condition, an average value is calculated.

According to a sixth aspect of the invention, in the operation control method of the indoor air conditioner of the first aspect, the method further comprises a normal temperature determining step for determining whether a temperature is normal temperature when the standby mode is established in the standby mode step and it is determined that automatic start time has not yet been elapsed in the automatic start time lapse determining step, and when it is determined that the temperature is not the normal temperature in the normal temperature determining step, the air conditioner is operated.

According to a seventh aspect of the invention, in the operation control method of the indoor air conditioner of the sixth aspect, a temperature determined in the normal temperature determining step is an outside temperature.

According to an eighth aspect of the invention, in the operation control method of the indoor air conditioner of the first aspect, humidity is used instead of the temperature.

A ninth aspect of the invention provides an indoor air conditioner having an OFF timer function for continuing operation until set time is elapsed, comprising, as input means, temperature setting means for setting a room temperature, OFF timer input means for starting the OFF timer function, OFF time input means for inputting the set time, and restart input means for carrying out restart at the time of a standby mode after the OFF timer is ended, comprising, as detecting means, room temperature detecting means for detecting a room temperature, comprising, as storing means, set temperature storing means for storing the room temperature set by the temperature setting means, OFF time storing means for storing OFF time which is input by the OFF time input means, history storing means for storing history when restart is input by the restart input means, automatic start time storing means for storing a time condition to carry out automatic start based on the history stored in the history storing means, and automatic start temperature storing means for storing a temperature condition to carry out automatic start based on the history stored in the history storing means, and comprising, as processing means, time measuring means for measuring time from start of the OFF timer function and time from end of the OFF timer function, standby mode ON/OFF means for functioning the standby mode for a predetermined time after the OFF timer function is ended, restarting means for carrying out the start when restart is input by the restart input means, and automatically starting means for carrying out the start by the time condition stored in the automatic start time storing means and the temperature condition stored in the automatic start temperature storing means, wherein time elapsed until the restart by the restart input means after the OFF timer is ended is stored in the automatic start time storing means as automatic start time, and the room temperature at the time of the restart is stored in the automatic start temperature storing means as the automatic start temperature.

According to a tenth aspect of the invention, in the indoor air conditioner of the ninth aspect, when time stored in the automatic start time storing means is elapsed and a current temperature reaches the room temperature stored in the automatic start temperature storing means, the automatic start is carried out by the automatically starting means.

According to an eleventh aspect of the invention, the indoor air conditioner of the ninth aspect further comprises automatic start condition calculating means for inputting time elapsed until restart is input by the restart input means after the standby mode is started, and the room temperature detected by the room temperature detecting means when the restart is input by the restart input means, thereby calculating the automatic start condition, the automatic start time storing means stores the time condition calculated by the automatic start condition calculating means, and the automatic start temperature storing means stores the temperature condition calculated by the automatic start condition calculating means.

According to the present invention, it is possible to automatically start the indoor air conditioner in accordance with a sleeping state or somesthesis of a user.

The first aspect of the present invention provides an operation control method of an indoor air conditioner having an OFF timer function for continuing operation until set time is elapsed, comprising: a standby mode step for establishing a standby mode after an OFF timer is ended, and an automatic start condition storing step for storing time elapsed until the restart time after the OFF timer is ended as automatic start time, and for storing a room temperature at the time of the restart as an automatic start temperature when restart is manually carried out at the time of the standby mode, when the standby mode is established in the standby mode step, an automatic start time lapse determining step for determining whether the already stored automatic start time is elapsed, and an automatic start temperature achievement determining step for determining whether a current temperature reaches the already stored automatic start temperature, wherein when it is determined that the automatic start time has not yet been elapsed in the automatic start time lapse determining step, automatic start is not carried out even if the current temperature reaches the automatic start temperature, even if it is determined that he automatic start time has been elapsed in the automatic start time lapse determining step, if it is determined that the current temperature does not reach the automatic start temperature in the automatic start temperature achievement determining step, the automatic start is not carried out, and when it is determined that the automatic start time has been elapsed in the automatic start time lapse determining step and that the current temperature reaches the automatic start temperature in the automatic start temperature achievement determining step, the automatic start is carried out. According to this aspect, time and temperature at which a user feels difficult to sleep are previously stored, and these conditions are met, the air conditioner is automatically started. Therefore, the air conditioner can be started in accordance with the sleeping state or somesthesis of the user.

According to the second aspect of the invention, in the operation control method of the indoor air conditioner of the first aspect, if restart is manually carried out when the standby mode is established in the standby mode step and it is determined that the automatic start time has not yet been elapsed in the automatic start time lapse determining step, time elapsed until the restart after the OFF timer is ended and a room temperature at the time of the restart are newly stored. According to this aspect, the automatic start condition can be changed in accordance with change in seasons for example.

According to the third aspect of the invention, in the operation control method of the indoor air conditioner of the second aspect, the newly stored time elapsed until the restart after OFF timer is ended and a room temperature at the time of the restart are applied as a new automatic start time and automatic start temperature instead of the already stored automatic start time and automatic start temperature. According to this aspect, the automatic start condition can be changed in accordance with the latest using state.

According to the fourth aspect of the invention, in the operation control method of the indoor air conditioner of the second aspect, an automatic start condition is calculated using the newly stored time elapsed until the restart after OFF timer is ended and a room temperature at the time of the restart, and the already stored automatic start time and automatic start temperature. According to this aspect, since a new condition is set while taking the past data into consideration, the condition is not varied by irregular state, and average condition can be set.

According to the fifth aspect of the invention, in the operation control method of the indoor air conditioner of the fourth aspect, in the calculation of the automatic start condition, an average value is calculated. According to this aspect, whenever the air conditioner is used, the condition can be set based on the average feeling of the user.

According to the sixth aspect of the invention, in the operation control method of the indoor air conditioner of the first aspect, the method further comprises a normal temperature determining step for determining whether a temperature is normal temperature when the standby mode is established in the standby mode step and it is determined that automatic start time has not yet been elapsed in the automatic start time lapse determining step, and when it is determined that the temperature is not the normal temperature in the normal temperature determining step, the air conditioner is operated. According to this aspect, the air conditioner can reliably follow abnormal weather such as sultry night.

According to the seventh aspect of the invention, in the operation control method of the indoor air conditioner of the sixth aspect, a temperature determined in the normal temperature determining step is an outside temperature. According to this aspect, it is possible to swiftly and reliably detect abnormal weather such as sultry night.

According to the eighth aspect of the invention, in the operation control method of the indoor air conditioner of the first aspect, humidity is used instead of the temperature. According to this aspect, the air conditioner can reliably be fit for a user or a region which is largely influenced by humidity.

According to the ninth aspect of the invention, time elapsed until the restart by the restart input means after the OFF timer is ended is stored in the automatic start time storing means as automatic start time, and the room temperature at the time of the restart is stored in the automatic start temperature storing means as the automatic start temperature. According to this aspect, time and temperature at which a user feels difficult to sleep are previously stored, and these conditions are met, the air conditioner is automatically started. Therefore, the air conditioner can be started in accordance with the sleeping state or somesthesis of the user.

According to the tenth aspect of the invention, in the indoor air conditioner of the ninth aspect, when time stored in the automatic start time storing means is elapsed and a current temperature reaches the room temperature stored in the automatic start temperature storing means, the automatic start is carried out by the automatically starting means. According to this aspect, the air conditioner is automatically started when the preset condition is met (time and temperature at which a user feels difficult to sleep). Therefore, the automatic start condition can be set in accordance with the sleeping state or somesthesis of the user.

According to the eleventh aspect of the invention, the indoor air conditioner of the ninth aspect further comprises automatic start condition calculating means for inputting time elapsed until restart is input by the restart input means after the standby mode is started, and the room temperature detected by the room temperature detecting means when the restart is input by the restart input means, thereby calculating the automatic start condition, the automatic start time storing means stores the time condition calculated by the automatic start condition calculating means, and the automatic start temperature storing means stores the temperature condition calculated by the automatic start condition calculating means. According to this aspect, the automatic start condition can be changed in accordance with change in seasons for example.

### BRIEF DESCRIPTION OF THE DRAWINGS

FIG. 1 is a block diagram showing a function of an indoor air conditioner according to an embodiment of the present invention; and

FIG. 2 is a flowchart showing an operation control method of the indoor air conditioner.

### BEST MODE FOR CARRYING OUT THE INVENTION

An embodiment of the present invention will be explained with reference to the drawings below.

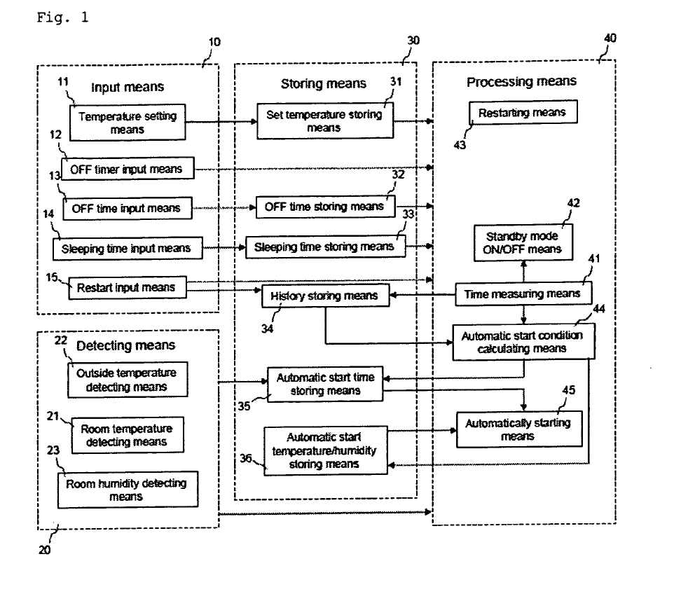

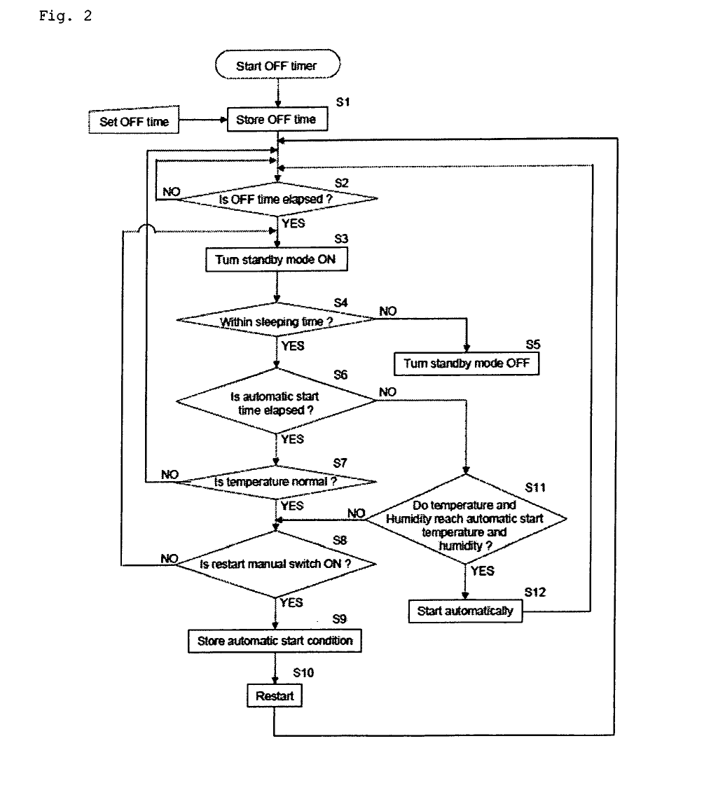

FIG. 1 is a block diagram showing a function of an indoor air conditioner according to the embodiment of the invention. FIG. 2 is a flowchart showing an operation control method of the indoor air conditioner.

First, a function of the indoor air conditioner of the embodiment will be explained.

As input means 10, the indoor air conditioner of the embodiment includes temperature setting means 11 for setting a room temperature, OFF timer input means 12 for starting an OFF timer function, OFF time input means 13 for inputting a set time, sleeping time input means 14 for inputting a sleeping time, and restart input means 15 for restarting the air conditioner at the time of a standby mode after the OFF timer is ended.

As detecting means 20, the air conditioner includes room temperature detecting means 21 for detecting a room temperature, outside temperature detecting means 22 for detecting an outside temperature, and room humidity detecting means 23 for detecting room humidity.

Further, as storing means 30, the air conditioner includes set temperature storing means 31 for storing a room temperature which is set by the temperature setting means 11, OFF time storing means 32 for storing OFF time which is input by the OFF time input means 13, sleeping time storing means 33 for storing sleeping time which is input by the sleeping time input means 14, history storing means 34 for storing a history when a restart is input by the restart input means 15, automatic start time storing means 35 for storing time condition to automatically start the air conditioner based on the history stored in the history storing means 34, and automatic start temperature/humidity storing means 36 for storing a temperature condition to automatically start the air conditioner based on the history stored in the history storing means 34.

As processing means 40, the air conditioner includes time measuring means 41 for measuring time from start of the OFF timer function and time from end of the OFF timer function, standby mode ON/OFF means 42 for allowing a standby mode to function for a predetermined time after the OFF timer function is ended, restarting means 43 for starting the air conditioner when the restart is input by the restart input means 15, automatic start condition calculating means 44 which inputs time between the start of the standby mode and the input of the restart by the restart input means 15, and inputs a room temperature detected by the room temperature detecting means 21 when the restart is input by the restart input means 15, and which calculates the automatic start condition, and automatically starting means 45 for starting the air conditioner based on the time condition stored in the automatic start time storing means 35 and the temperature condition stored in the automatic start temperature/humidity storing means 36.

A temperature which is set by the temperature setting means 11 is used as an operating condition by the OFF timer, but a set temperature at the time of normal operation may be used as it is.

If the OFF timer input means 12 inputs, the OFF timer operation is carried out by the processing means 40.

A user can set time using the OFF time input means 13, but a constant time may be previously determined, and the time may be automatically set by input of the OFF timer input means 12.

The sleeping time input means 14 is not limited to means in which the sleeping time is set by a user, and a standard time from sleep to wake-up may be previously set therein. The sleeping time input means 14 may be means for detecting the sleeping time by an illumination sensor, or a standard sleeping time zone may be set from a clock function.

The automatic start time storing means 35 stores, as automatic start time, time from the end of the OFF timer to the restart by the restart input means 15. When the restart by the restart input means 15 is carried out two or more times, the automatic start time storing means 35 stores a time condition calculated by the automatic start condition calculating means 44.

The automatic start temperature/humidity storing means 36 stores, as automatic start temperature, a room temperature at the time of restart. The restart by the restart input means 15 is carried out two or more times, the automatic start temperature/humidity storing means 36 stores a temperature condition calculated by the automatic start condition calculating means 44.

When the restart is carried out two times or more, the automatic start condition calculating means 44 calculates an automatic start condition using the newly stored time elapsed until the restart after OFF timer is ended and a room temperature at the time of restart, and the already stored automatic start time and automatic start temperature. In this calculation of the automatic start condition, it is preferable to calculate the average value, but application ratios of the newly stored time elapsed until the restart after OFF timer is ended and a room temperature at the time of restart may be enhanced.

The automatic start condition calculating means 44 may apply the newly stored time elapsed until the restart after OFF timer is ended and a room temperature at the time of restart as new automatic start time and automatic start temperature instead of already stored automatic start time and automatic start temperature.

The automatically starting means 45 automatically starts the air conditioner when time stored in the automatic start time storing means 35 is elapsed and the temperature reaches the room temperature stored in the automatic start temperature/humidity storing means 36.

Next, an operation control method of the indoor air conditioner according to the embodiment will be explained using FIG. 2.

The operation time of the OFF timer is stored in the OFF time storing means 32 when it is input by the OFF timer input means 12 (S1).

If the OFF timer is started, it is determined whether the stored OFF time is elapsed (S2), and the operation by the OFF timer is continued until the OFF time is elapsed.

If it is determined in step 2 that the OFF time is elapsed, the procedure is shifted to a standby mode step (S3). In step 3, the operation by the OFF timer is stopped, the standby mode is turned ON by the standby mode ON/OFF means 42.

Next, in step 4, it is determined whether the time is within the sleeping time stored in the sleeping time storing means 33. When the previously stored sleeping time is elapsed, the standby mode is ended by the standby mode ON/OFF means (S5).

If it is determined in step 4 that the time is within sleeping time, it is determined whether the automatic start time is elapsed (S6). Since the automatic start time is not stored in the initial stage, it is determined that the automatic start time is not elapsed. Therefore, sleeping time may be applied as the automatic start time as an initial set value.

If it is determined in step 6 that the current time is before automatic start time, it is determined whether the temperature and humidity are normal temperature and humidity (S7). In the determination in step 7, abnormal weather such as sultry night is determined. Therefore, conditions of sultry night such as a temperature may be previously stored, or a predetermined value may be added to or subtracted from temperature/humidity stored as automatic start temperature/humidity and the abnormal temperature/humidity may be determined.

When it is determined in step 7 that the temperature/humidity are not normal temperature/humidity, the air conditioner is started. In this case, in this embodiment, the operation of the OFF timer is again restarted.

When it is determined in step 7 that the temperature/humidity are normal temperature/humidity, it is determined whether input is carried out by the restart input means 15 (S8).

In step 8, if a restart manual switch is not turned ON, the state is returned to the standby mode state of step 3, and monitor is continued.

In step 8, if the restart manual switch is turned ON (manually restarted), time elapsed after the OFF timer is ended to the restart time, and a room temperature at the time of restart are stored in the history storing means 34 (S9).

In step 9, if it is the first time, the automatic start condition calculating means 44 stores time elapsed until the restart time after the OFF timer is ended in the automatic start time storing means 35 as the automatic start time, and stores the room temperature at the time of restart in the automatic start temperature/humidity storing means 36 as the automatic start temperature. When the restart has already been carried out, the automatic start condition calculating means 44 calculates an automatic start condition using the newly stored time elapsed until the restart after OFF timer is ended and a room temperature at the time of restart, and already stored automatic start time and automatic start temperature.

When the restart manual switch is turned ON (manually restarted) in step 8, the restart is carried out (S10). The restart operation is carried out only during OFF time, but this may be operating time which is determined separately from the OFF time.

If it is determined that the automatic start time is elapsed in step 6, the automatically starting means 45 determines whether a temperature and humidity detected by the room temperature detecting means 21 and the room humidity detecting means 23 reach the automatic start temperature/humidity stored in the automatic start temperature/humidity storing means 36 (S11).

If it is determined in step 11 that the temperature and humidity do not reach the automatic start temperature/humidity, the procedure is returned to step 8 where it is determined whether the restart manual switch is turned ON.

If it is determined in step 11 that the temperature and humidity reach the automatic start temperature/humidity, the air conditioner is automatically started by the automatically starting means 45 (S12). The automatic start operation is carried out only during OFF time, but this may be operating time which is determined separately from the OFF time.

Although the temperature and humidity are used in this embodiment, only the temperature may be detected and determined or only the humidity may be detected and determined.

According to the embodiment, when it is determined that the automatic start time has not yet been elapsed in the automatic start time lapse determination step (S6), the automatic start is not carried out even when the temperature reaches the automatic start time. Even if the automatic start time is elapsed in the automatic start time lapse determination step (S6), if it is determined that the temperature does not reach the automatic start temperature in the automatic start temperature achievement determining step (S11), the automatic start is not carried out, and when it is determined in the automatic start time lapse determining step (S6) that the automatic start time is elapsed and it is determined in the automatic start temperature achievement determining step (S11) that the temperature reached the automatic start temperature, the automatic start is carried out. Therefore, the air conditioner can automatically be started in accordance with sleeping state or somesthesis of a user.

In this embodiment, when the standby mode is selected in the standby mode step (S3) and it is determined that the automatic start time has not yet been elapsed in the automatic start time lapse determining step (S6), if the restart is manually carried out (S8), time elapsed until the restart time after the OFF timer is ended and a room temperature at the time of restart are newly stored (S9). Therefore, according to the embodiment, condition of the automatic start can be changed in accordance with change of seasons.

In this embodiment, when the standby mode is selected in the standby mode step (S3) and it is determined that the automatic start time has not yet been elapsed in the automatic start time lapse determining step (S6), the invention has a normal temperature determining step (S7) for determining whether a temperature is a normal temperature. When it is determined that the temperature is not normal temperature in the normal temperature determining step (S7), the air conditioner is operated. Therefore, according to the embodiment, it is possible to reliably handle abnormal weather such as sultry night.

The indoor air conditioner and its operation control method according to the present invention can also be applied as a cooler, a heater or an air conditioner using a refrigeration cycle, and can also be applied to a warm-air heater, a floor heater, an electric carpet and an electric blanket using electricity, gas petroleum.

1. An operation control method of an indoor air conditioner having an OFF timer function for continuing operation until set time is elapsed, comprising:
a standby mode step for establishing a standby mode after an OFF timer is ended, and
an automatic start condition storing step for storing time elapsed until the restart time after the OFF timer is ended as automatic start time, and for storing a room temperature at the time of the restart as an automatic start temperature when restart is manually carried out at the time of the standby mode,
when the standby mode is established in the standby mode step,
an automatic start time lapse determining step for determining whether the already stored automatic start time is elapsed, and
an automatic start temperature achievement determining step for determining whether a current temperature reaches the already stored automatic start temperature, wherein
when it is determined that the automatic start time has not yet been elapsed in the automatic start time lapse determining step, automatic start is not carried out even if the current temperature reaches the automatic start temperature,
even if it is determined that the automatic start time has been elapsed in the automatic start time lapse determining step, if it is determined that the current temperature does not reach the automatic start temperature in the automatic start temperature achievement determining step, the automatic start is not carried out, and
when it is determined that the automatic start time has been elapsed in the automatic start time lapse determining step and that the current temperature reaches the automatic start temperature in the automatic start temperature achievement determining step, the automatic start is carried out.

2. The operation control method of the indoor air conditioner according to claim 1, wherein if restart is manually carried out when the standby mode is established in the standby mode step and it is determined that the automatic start time has not yet been elapsed in the automatic start time lapse determining step, time elapsed until the restart after the OFF timer is ended and a room temperature at the time of the restart are newly stored.

3. The operation control method of the indoor air conditioner according to claim 2, wherein the newly stored time elapsed until the restart after OFF timer is ended and a room temperature at the time of the restart are applied as a new automatic start time and automatic start temperature instead of the already stored automatic start time and automatic start temperature.

4. The operation control method of the indoor air conditioner according to claim 2, wherein an automatic start condition is calculated using the newly stored time elapsed until the restart after OFF timer is ended and a room temperature at the time of the restart, and the already stored automatic start time and automatic start temperature.

5. The operation control method of the indoor air conditioner according to claim 4, wherein in the calculation of the automatic start condition, an average value is calculated.

6. The operation control method of the indoor air conditioner according to claim 1, further comprising a normal temperature determining step for determining whether a temperature is normal temperature when the standby mode is established in the standby mode step and it is determined that automatic start time has not yet been elapsed in the automatic start time lapse determining step, wherein
when it is determined that the temperature is not the normal temperature in the normal temperature determining step, the air conditioner is operated.

7. The operation control method of the indoor air conditioner according to claim 6, wherein a temperature determined in the normal temperature determining step is an outside temperature.

8. The operation control method of the indoor air conditioner according to claim 1, wherein humidity is used instead of the temperature.

9. An indoor air conditioner having an OFF timer function for continuing operation until set time is elapsed, comprising, as input means,
temperature setting means for setting a room temperature, OFF timer input means for starting the OFF timer function, OFF time input means for inputting the set time, and restart input means for carrying out restart at the time of a standby mode after the OFF timer is ended,
comprising, as detecting means,
room temperature detecting means for detecting a room temperature,
comprising, as storing means,
set temperature storing means for storing the room temperature set by the temperature setting means,
OFF time storing means for storing OFF time which is input by the OFF time input means,
history storing means for storing history when restart is input by the restart input means,
automatic start time storing means for storing a time condition to carry out automatic start based on the history stored in the history storing means, and
automatic start temperature storing means for storing a temperature condition to carry out automatic start based on the history stored in the history storing means, and
comprising, as processing means,
time measuring means for measuring time from start of the OFF timer function and time from end of the OFF timer function,
standby mode ON/OFF means for functioning the standby mode for a predetermined time after the OFF timer function is ended,
restarting means for carrying out the start when restart is input by the restart input means, and
automatically starting means for carrying out the start by the time condition stored in the automatic start time storing means and the temperature condition stored in the automatic start temperature storing means, wherein
time elapsed until the restart by the restart input means after the OFF timer is ended is stored in the automatic start time storing means as automatic start time, and the room temperature at the time of the restart is stored in the automatic start temperature storing means as the automatic start temperature.

10. The indoor air conditioner according to claim 9, wherein when time stored in the automatic start time storing means is elapsed and a current temperature reaches the room temperature stored in the automatic start temperature storing means, the automatic start is carried out by the automatically starting means.

11. The indoor air conditioner according to claim 9, further comprising automatic start condition calculating means for inputting time elapsed until restart is input by the restart input means after the standby mode is started, and the room temperature detected by the room temperature detecting means when the restart is input by the restart input means, thereby calculating the automatic start condition, wherein
the automatic start time storing means stores the time condition calculated by the automatic start condition calculating means, and
the automatic start temperature storing means stores the temperature condition calculated by the automatic start condition calculating means.
